(19) United States
(12) Patent Application Publication
(10) Pub. No.: US 2017/0043353 A1
(43) Pub. Date: Feb. 16, 2017

(54) Suction Dredge Lift Station

(71) Applicants: Frank E. Reed, Hayden, ID (US); David S. Peterson, Kalispell, MT (US)

(72) Inventors: Frank E. Reed, Hayden, ID (US); David S. Peterson, Kalispell, MT (US)

(21) Appl. No.: 14/824,025

(22) Filed: Aug. 11, 2015

(51) Int. Cl. B03B 11/00; E02F 3/90; E02F 7/10

(52) U.S. Cl. CPC B03B 11/00; E02F 7/10; E02F 3/90

(57) ABSTRACT

a mining dredge lift station having an elevatable hopper, wherein the hopper has an air opening and a dredge inlet, and where the hopper is in material communication with a tapered feed, to direct a material flow into a lift feed, wherein the lift feed connected in material communication to the tapered feed. The lift feed is curved from a lift feed opening with a generally downward orientation to a lift feed accelerated outlet with a generally upward direction of flow. A high-pressure hose attachment is connected to the lift feed at the outer radius of the curve, to orient a line-of-flow upward in the direction of the desired elevation for the mining material.

### CROSS-REFERENCE TO RELATED APPLICATIONS

This application claims the benefit of patent application No. 62/035,562, filed 11 Aug. 2014 by the present inventors.

### STATEMENT REGARDING FEDERALLY SPONSORED RESEARCH OR DEVELOPMENT

Not Applicable

### BACKGROUND OF THE INVENTION

Field of the Invention

This invention generally relates to the field of gold or gem mining, and more specifically to lift stations for suction dredge operations.

Description of the Related Art

A number of methods are typically used to mine gold and gems from the earth's surface. In this disclosure, the material being mined will be referred to simply as “gold,” but other heavy metals, valuable materials and gems may still be includable in that term. This disclosure will also use the term “deposit material” to refer to the mix of gold and non-gold naturally found at a mining site. The simplest technique to separate gold from the non-gold material is panning. In panning some deposit material is placed in a large plastic or metal pan, along with a generous amount of water. The pan is then agitated so that the gold particles, being of higher density than the non-gold material, settle to the bottom. The non-gold material is flushed from the pan with the water, leaving the desired gold left in the bottom of the pan. Concentric, circumferential ribs are frequently added to the sides of the pan to provide additional low spots for the gold to settle during agitation.

The agitation in a pan can be circular or linear, and is caused by the motion of the pan in the hands of the miner. The waves created by the motion accelerate the non-gold particles, and keep them suspended, while the denser settle to the low spots in the pan.

Sluice boxes and rocker boxes work on a similar principle, just on a slightly larger scale. Rocker boxes tend to be slightly smaller, and both the deposit material and water are generally fed by hand. Improvements include using a filter blanket on the bottom of the box to capture the fine pieces of gold. Sluice boxes, as their name implies, are fed by a sluice, or water flow. Parallel ridges on the bottom of the sluice box, perpendicular to the flow of water, trap the heavier gold particles as the water washes them, while the non-gold material is removed with the water. The pitch of the sluice box and the rate of the water flow can be adjusted to optimize capture of the particular size of gold particles in the deposit material.

The side to side agitation of the rocker box, and the latter will slow agitation of the sluice box, both are seen to create horizontal swirls, or vortices, that agitate the deposit material. The non-gold material is accelerated in the swirled flow, and thereby continues to be suspended in the swirling water. The gold, however, because it is being denser, resists the swirling motion and settles in the low spots in the boxes.

To facilitate separation, deposit material and water must be displaced from the earth and transported to the separation device. An effective method is a suction dredge, which uses the rapid movement of pumped water to create a suction, which displaces the deposit material and transport the deposit material along with the water. Limitations on the mass of deposit material a suction dredge can transport up an elevations creates the need for lift stations designed to transport a substantial mass of deposit material up a required elevation to the top of a separation mechanism, such as a sluice box.

It would be a valuable addition to the prior art to have a lift station that is easily man portable, and operatable with equipment available at a mining-related dredging operation, such as water pumps, hand operated dredges, and flexible dredging operations hose and tubing. It would also be an addition to the art for the lift station to function with no moving parts. It would also be an addition to the art for the lift station to be combined with additional, supplemental lift stations in series to achieve greater elevation transport heights.

### BRIEF DESCRIPTION OF THE DRAWINGS

The invention will be explained in conjunction with an illustrative embodiment shown in the accompanying drawings, in which:

FIG. 1 is a schematic side view of an exemplary lift station according to the present disclosure; and

FIG. 2 is an illustration of an exemplary lift station in operation.

### DESCRIPTION OF THE ILLUSTRATED EMBODIMENT

In this description the terms down, downward, top, bottom, lower, higher, up, and upward are used from the perspective of the lift station being in an operational configuration and position, and are in reference to a relationship to the ground. As such downward words mean in the direction toward the ground, as in the direction of gravitational force, and upward words mean in the direction opposite the gravitational force, as toward the sky. The term “parallel to the ground” is used as the non-inclusive transition plane between up and down. As such, and increase in elevation may be understood to be an upward direction.

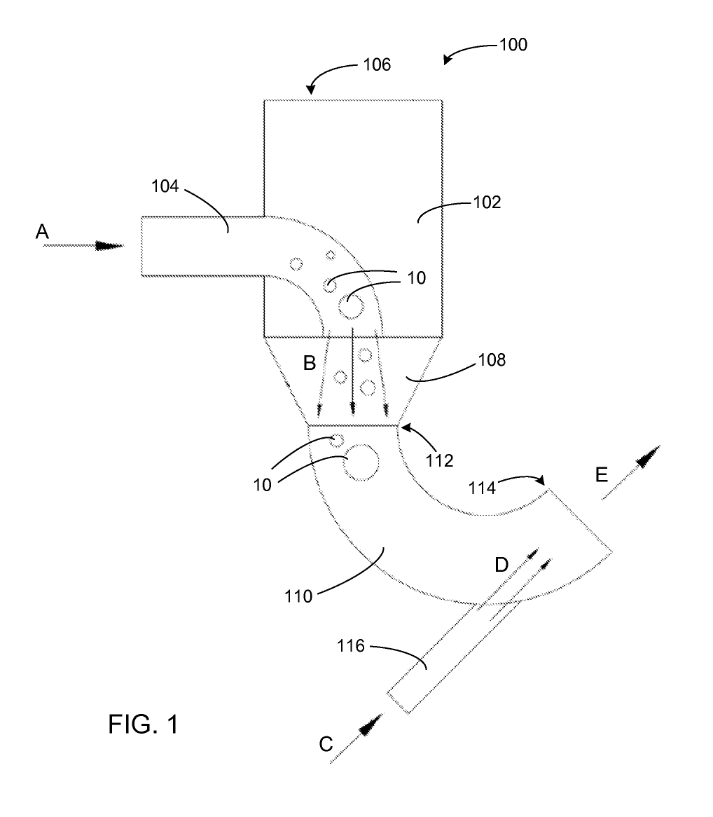

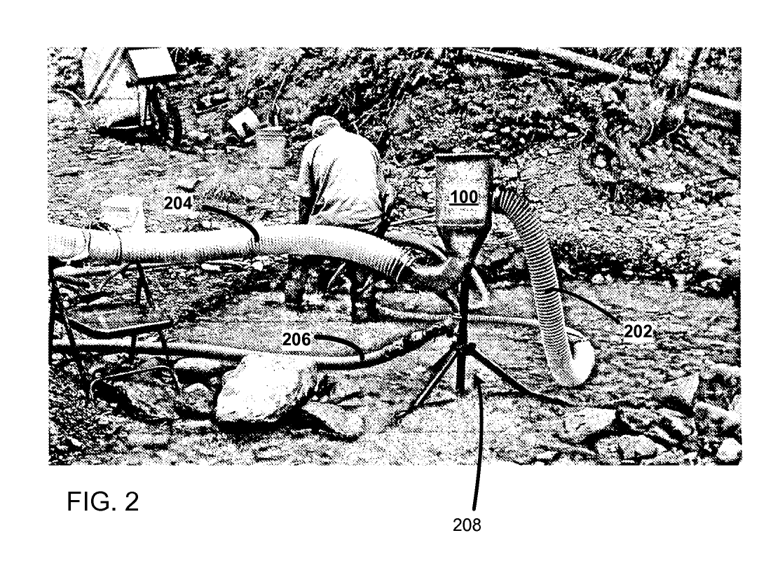

Referring to FIGS. 1 and 2, an exemplary lift station 100 is shown including exemplary mining material 10 suspended in moving water creating a material flow. The exemplary lift station 100 has a hopper 102 that has a dredge inlet 104. The hopper 102 is supportable by a stand to elevate it off the ground and provide room for other components to be located under the hopper 102. The dredge inlet 104 is configured to deposit a material flow into the hollow interior of the hopper 102. Exemplary hopper 104 has an open top to provide as an air opening 106 to prevent flow pressure from inhibiting the flow of material through the hopper 102. The material flow with mining material 10 deposited into the hopper 102 flow and falls into an exemplary taper feed 108, which directs the material flow into an exemplary lift feed 110. Since the exemplary hopper 102 has a greater cross-sectional diameter than the exemplary lift feed 110, the exemplary taper feed 108 provides for the narrowing of the material flow.

The lift feed 110 has a lift feed opening 112 that received the material flow from the taper feed 108. The exemplary lift feed opening 112 may be seen as a cross-section of the lift feed 110, and as such is oriented generally parallel to the ground. As the interface with the taper feed 108, the lift feed opening 112 is oriented perpendicular to the material flow. The lift feed 110 forms a curve from the lift feed opening 112, to the exemplary lift feed accelerated outlet 114 at the other end of the lift feed 110. The exemplary lift feed accelerated outlet 114 may be seen as a cross-section of the lift feed 110, and as such is oriented perpendicular to a line upward from parallel to the ground.

Also depicted is an exemplary material flow path A to B, into the lift feed 110. A high-pressure hose attachment 116 is connected to provide directional fluid flow C into the material flow within lift feed 110 at a material flow interface D. The exemplary high-pressure hose attachment 116 accesses the outer curved exterior of the lift feed 110 to accelerate the material flow upward, as in resultant lift flow E, to achieve the lift function of the lift station 100. A typical dredging operation pump has the ability to lift the material flow, containing mining material 10, 2 feet, 3 feet, 4 feet, or more above the operational level of the lift station 100.

The curve of the lift feed may be measured from a horizontal line at the lift feed opening 112 to straight line perpendicular across a resultant lift flow E out of the lift feed accelerated outlet 114. Since the resultant lift flow E is upward from horizontal, the angle from the horizontal line at the lift feed opening 112 to the straight line at the lift feed accelerated outlet 114 is greater than 90 degrees. The angle from the horizontal line at the lift feed opening 112 to the straight line at the lift feed accelerated outlet 114 could be 180 degrees, directing the resultant lift flow E straight up. To account for any lateral travel to direct the resultant lift flow E into a separation device or subsequent lift station 100, the angle is described herein as “less than 180 degrees.”

A plurality of the presently described lift station 100 may be used is series to achieve greater material flow lift elevations. This may be achieved by directing the resultant lift flow E of one lift station 100 into the dredge inlet 104 of a subsequent lift station 100. The number of lift stations 100 that can be combined in series appears to only be limited by the availability of equipment and water to provide for an adequate supply of directional fluid flows C. Each lift station 100 may incrementally lift the material flow in the range of 2 to 4 feet. However, the extent of the lift may be greater than 4 feet, if the lift station 100 is appropriately stabilized and aligned, and there is an adequate volume of material flow B into the lift feed 110 and directional fluid flow C.

Focusing now to FIG. 2, an exemplary lift station 100 is shown in an operational scenario. A dredge hose 202 is connected to the dredge inlet 104 to provide material flow A containing mining material 10. Lift flow hose 204 is shown connected to the lift fee accelerated outlet 114 of the lift feed 110, and transporting resultant lift flow E to an adjacent sluice box (not shown). High-pressure hose 206 is connected to high-pressure hose attachment 116, and shown to curve so as to provide a directional material flow interface D directing the material flow D in a straight-line direction toward the lift feed accelerated outlet 114, and into the lift flow hose 204. The entire lift station 100 is shown to be supported off the mining operation ground by an exemplary, height-adjustable support stand 208.

Examples of the claim scope that may be made to the subject matter of this disclosure may include a mining dredge lift station comprising a hopper elevatable off the ground, said hopper having an air opening and a dredge inlet, the hopper in material communication with a tapered feed, to direct a material flow into a lift feed, said lift feed connected in material communication to the tapered feed, the lift feed having a curve from a lift feed opening, with a generally horizontal cross-section, to a lift feed accelerated outlet, with a cross-section perpendicular to an upward direction of flow, said curve having an outer radius, and a high-pressure hose attachment connected to the lift feed at the outer radius of the curve, with a line-of-flow perpendicular to the cross-section of the lift feed accelerated outlet and directed upward from horizontal.

The claim scope may also include that the hopper and the lift feed each have a cross-sectional area, and the lift feed cross-sectional area is smaller. The claim scope may also include an angle between the cross-section of the inlet and the cross-section of the accelerated outlet being greater than 90 degrees, the angle being less than 180 degrees, and the angle being greater than 90 degrees, but less than 180 degrees.

The claim scope may also include a support stand attached to the hopper to elevate the hopper up from a mining operation surface.

The claim scope may also include the resultant lift flow capable of transporting mining material to an elevation of at least 2 feet above the lift feed accelerated outlet, an elevation of at least 3 feet above the lift feed accelerated outlet, an elevation of at least 4 feet above the lift feed accelerated outlet, and an approximate elevation range of between 2 feet and 4 feet above the lift feed accelerated outlet.

Additionally, the claim scope may include a mining dredge lift station comprising at least two stages, each stage comprising a hopper with an air opening and a material inlet, the hopper in material communication with a tapered feed, to direct a material flow into a lift feed, said lift feed connected in material communication to the tapered feed, the lift feed having a curve from a lift feed opening, with a cross-section generally parallel to the ground, to a lift feed accelerated outlet, with a cross-section perpendicular to an upward direction of flow, said curve having an outer radius, a high-pressure hose attachment connected to the lift feed at the outer radius of the curve, to orient a line-of-flow upward, perpendicular to the cross-section of the lift feed accelerated outlet, and a connection hose from the accelerated outlet of one lift station to the material inlet tube of a subsequent lift station.

The claim scope may also include that in each corresponding pair of a hopper and a lift feed, the hopper and the lift feed each having a cross-sectional area, and each lift feed cross-sectional area being smaller.

The claim scope may also include that in at least one said lift feed an angle between the cross-section of the inlet and the cross-section of the accelerated outlet being greater than 90 degrees, the angle being less than 180 degrees, and the angle being greater than 90 degrees, but less than 180 degrees.

The claim scope may also include a support stand attached to each corresponding hopper, and that each support stand independently adjustable to elevate the corresponding hopper upward to a desired height from a mining operation surface.

The claim scope may also include that at least one of the resultant lift flows is capable of transporting mining material to an elevation of at least 2 feet above a preceding lift feed accelerated outlet, to an elevation of at least 3 feet above a preceding lift feed accelerated outlet, to an elevation of at least 4 feet above a preceding lift feed accelerated outlet, and to an approximate elevation range of between 2 feet and 4 feet above the lift feed accelerated outlet.

The exemplary embodiment is describe in U.S. patent application No. 62/035,562, filed 11 Aug. 2014 by the present inventors, which is hereby incorporated by reference in order to ensure any patentable subject matter therein disclosed is available as teaching to this disclosure.

These examples illustrate only a few configurations that are considered by the inventor within the scope of this disclosure. The foregoing disclosure and description of the invention is illustrative and explanatory thereof. Various changes in the details of the illustrated construction may be made within the scope of the appended claims without departing from the spirit of the invention. The present invention should only be limited by the following claims and their legal equivalents.

I claim:

1. A mining dredge lift station comprising:
a hopper, said hopper having an air opening and a dredge inlet;
the hopper in material communication with a tapered feed, to direct a material flow into a lift feed, said lift feed connected in material communication to the tapered feed;
the lift feed having a curve from a lift feed opening, with a generally horizontal cross-section, to a lift feed accelerated outlet, with a cross-section perpendicular to an upward direction of flow, said curve having an outer radius; and
a high-pressure hose attachment connected to the lift feed at the outer radius of the curve, with a line-of-flow perpendicular to the cross-section of the lift feed accelerated outlet and directed upward from horizontal.

2. The mining dredge lift station of claim 1, further comprising:
the hopper and the lift feed each having a cross-sectional area, and the lift feed cross-sectional area being smaller.

3. The mining dredge lift station of claim 1, further comprising:
an angle between the cross-section of the inlet and the cross-section of the accelerated outlet being greater than 90 degrees.

4. The mining dredge lift station of claim 1, further comprising:
an angle between the cross-section of the inlet and the cross-section of the accelerated outlet being less than 180 degrees.

5. The mining dredge lift station of claim 1, further comprising:
an angle between the cross-section of the inlet and the cross-section of the accelerated outlet being greater than 90 degrees, but less than 180 degrees.

6. The mining dredge lift station of claim 1, further comprising:
a support stand attached to the hopper to elevate the hopper up from a mining operation surface.

7. The mining dredge lift station of claim 1, wherein the resultant lift flow capable of transporting mining material to an elevation of at least 2 feet above the lift feed accelerated outlet.

8. The mining dredge lift station of claim 1, wherein the resultant lift flow capable of transporting mining material to an elevation of at least 3 feet above the lift feed accelerated outlet.

9. The mining dredge lift station of claim 1, wherein the resultant lift flow capable of transporting mining material to an elevation of at least 4 feet above the lift feed accelerated outlet.

10. The mining dredge lift station of claim 1, wherein the resultant lift flow capable of transporting mining material to an approximate elevation range of between 2 feet and 4 feet above the lift feed accelerated outlet.

11. A mining dredge lift station comprising:
at least two stages, each stage comprising a hopper with an air opening and a material inlet, the hopper in material communication with a tapered feed, to direct a material flow into a lift feed, said lift feed connected in material communication to the tapered feed, the lift feed having a curve from a lift feed opening, with a cross-section generally parallel to the ground, to a lift feed accelerated outlet, with a cross-section perpendicular to an upward direction of flow, said curve having an outer radius, a high-pressure hose attachment connected to the lift feed at the outer radius of the curve, to orient a line-of-flow upward, perpendicular to the cross-section of the lift feed accelerated outlet; and
a connection hose from the accelerated outlet of one lift station to the material inlet tube of a subsequent lift station.

12. The mining dredge lift station of claim 11, further comprising:
in each corresponding pair of a hopper and a lift feed, the hopper and the lift feed each having a cross-sectional area, and each lift feed cross-sectional area being smaller.

13. The mining dredge lift station of claim 11, further comprising:
in at least one said lift feed an angle between the cross-section of the inlet and the cross-section of the accelerated outlet being greater than 90 degrees.

14. The mining dredge lift station of claim 11, further comprising:
in at least one said lift feed an angle between the cross-section of the inlet and the cross-section of the accelerated outlet being less than 180 degrees.

15. The mining dredge lift station of claim 11, further comprising:
in at least one said lift feed an angle between the cross-section of the inlet and the cross-section of the accelerated outlet being greater than 90 degrees, but less than 180 degrees.

16. The mining dredge lift station of claim 11, further comprising:
a support stand attached to each corresponding hopper; and
each support stand independently adjustable to elevate the corresponding hopper upward to a desired height from a mining operation surface.

17. The mining dredge lift station of claim 11, wherein at least one of the resultant lift flows is capable of transporting mining material to an elevation of at least 2 feet above a preceding lift feed accelerated outlet.

18. The mining dredge lift station of claim 11, wherein at least one of the resultant lift flows is capable of transporting mining material to an elevation of at least 3 feet above a preceding lift feed accelerated outlet.

19. The mining dredge lift station of claim 11, wherein at least one of the resultant lift flows is capable of transporting mining material to an elevation of at least 4 feet above a preceding lift feed accelerated outlet.

20. The mining dredge lift station of claim 11, wherein at least one of the resultant lift flow capable of transporting mining material to an approximate elevation range of between 2 feet and 4 feet above the lift feed accelerated outlet.
